(19) United States
(12) Patent Application Publication
(10) Pub. No.: US 2009/0241767 A1
(43) Pub. Date: Oct. 1, 2009

(54) DIAPHRAGM CYLINDER DEVICE

(75) Inventor: Kenji MURAMATSU, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/413,878

(22) Filed: Mar. 30, 2009

(30) Foreign Application Priority Data
Mar. 28, 2008 (JP) 2008-085201

(51) Int. Cl. F16J 3/00

(52) U.S. Cl. 92/96

(57) ABSTRACT

A diaphragm cylinder device may include a cylinder chamber, a piston disposed in an inside of the cylinder chamber, and a diaphragm for forming a chamber in the cylinder chamber where fluid is flown into and flown out. A fixed body includes an outer peripheral side deformation restricting part for restricting deformation of an outer peripheral side ring portion of the diaphragm when the piston is displaced, and the piston includes an inner peripheral side deformation restricting part for restricting deformation of the inner peripheral side ring portion of the diaphragm when the piston is displaced. Displacement of the piston in a direction toward a top dead point for decreasing an internal volume of the chamber and in a direction toward a bottom dead point for increasing the internal volume of the chamber is interlocked with flowing-out and flowing-in of the fluid in the chamber.

### CROSS REFERENCE TO RELATED APPLICATION

The present invention claims priority under 35 U.S.C. §119 to Japanese Application No. 2008-085201 filed Mar. 28, 2008, the contents of which are incorporated herein by reference.

### FIELD OF THE INVENTION

An embodiment of the present invention may relate to a diaphragm cylinder device in which a so-called rolling diaphragm is used.

### BACKGROUND OF THE INVENTION

As shown in FIGS. 5(a) and 5(b), a diaphragm cylinder device with the use of a rolling diaphragm includes a cylinder chamber 8 which is formed in a fixed body 10, a piston 6 which is disposed in the cylinder chamber 8, and a diaphragm 7 whose outer peripheral side and inner peripheral side are respectively fixed to the fixed body 10 and the piston 6. A chamber 80 where fluid is flown into or out is partitioned by the diaphragm 7 in the cylinder chamber 8 (see, Japanese Utility Model Laid-Open No. Sho 63-22403, Japanese Patent Laid-Open No. 2001-99109 and Japanese Patent Laid-Open No. 2005-237637).

In the cylinder device which is structured as described above, a center portion in a radial direction of the diaphragm 7 is formed to be a deformable part 73 and, when the piston is displaced, the diaphragm 7 is deformed so that a turning-back portion 79 formed in a “U”-shape in cross section is moved to vary an internal volume of the chamber 80. In this case, when an outer peripheral side ring portion 72 of the diaphragm 7 between an outer peripheral side held part 71 which is held by the fixed body 10 and the deformable part 73, and an inner peripheral side ring portion 74 between an inner peripheral side held part 75 which is held by the piston 6 and the deformable part 73 are respectively formed to be a non-deformable part which does not deform regardless of displacement of the piston 6, linearity is secured between an internal volume of the chamber 80 and the position of the piston 6.

In the diaphragm cylinder device as described above, when the piston 6 is driven to move in an axial direction, a volume of the chamber 80 is varied to cause fluid to flow in and flow out in the chamber 80 and thus the diaphragm cylinder device may be used as a pump device. Alternatively, when fluid is made to flow in and flow out in the chamber 80, the piston 6 is moved in the axial direction. Therefore, when this movement is outputted to the outside, the diaphragm cylinder device may be used as an actuator.

In the diaphragm cylinder device structured as described above, when fluid is made to flow in and flow out in the chamber 80 or, when the piston 6 is driven to move in an axial direction, the outer peripheral side ring portion 72 and the inner peripheral side ring portion 74 are also deformed and thus linearity between the internal volume of the chamber 80 and the position of the piston 6 is lowered to deteriorate an operating characteristic as an actuator or as a pump device. Further, when unnatural deformation is occurred in the diaphragm 7, the diaphragm 7 deteriorates in a short term.

Especially, in a case that the diaphragm cylinder device is used as a pump device, when the piston 6 is displaced toward the bottom dead point side, the inside of the chamber 80 becomes in a negative pressure state. Therefore, as shown by alternate long and short dash lines in FIG. 5(b), the outer peripheral side ring portion 72 and/or the inner peripheral side ring portion 74 may be deformed due to the negative pressure in the chamber 80. When this deformation is occurred, linearity between the internal volume of the chamber 80 and the position of the piston 6 is lowered to deteriorate discharging accuracy of the pump device.

### SUMMARY OF THE INVENTION

In view of the problems described above, at least an embodiment of the present invention may advantageously provide a diaphragm cylinder device which may be capable of improving an operating characteristic as a pump device or an actuator by means of that unnecessary deformation is prevented from being occurred in a diaphragm.

In order to solve the problems described above, at least an embodiment of the present invention provides a diaphragm cylinder device including a cylinder chamber which is extended in an axial direction in a fixed body, a piston which is disposed in an inside of the cylinder chamber, and a diaphragm whose outer peripheral side and inner periphery side are respectively fixed to the fixed member and the piston for forming a chamber in the cylinder chamber where fluid is flown into and flown out. The diaphragm includes an outer peripheral side held part which is held by the fixed body, an inner peripheral side held part which is held by the piston, and a deformable part in which a turning-back portion formed in a “U”-shape in cross section is moved between the outer peripheral side held part and the inner peripheral side held part by displacement of the piston to vary an internal volume of the chamber. The fixed body includes an outer peripheral side deformation restricting part which supports an outer peripheral side ring portion that is located between the outer peripheral side held part and the deformable part of the diaphragm on an inner peripheral side with respect to the outer peripheral side ring portion in the chamber for restricting deformation of the outer peripheral side ring portion when the piston is displaced. The piston includes an inner peripheral side deformation restricting part which supports an inner peripheral side ring portion that is located between the inner peripheral side held part and the deformable part of the diaphragm on an outer peripheral side with respect to the inner peripheral side ring portion in the chamber for restricting deformation of the inner peripheral side ring portion when the piston is displaced. In this state, displacement of the piston in a direction toward a top dead point for decreasing an internal volume of the chamber and in a direction toward a bottom dead point for increasing the internal volume of the chamber is performed in an interlocked manner with flowing-out and flowing-in of the fluid in the chamber.

In accordance with an embodiment of the present invention, an outer peripheral side deformation restricting part is structured for supporting an outer peripheral side ring portion that is located between the outer peripheral side held part and the deformable part of the diaphragm to restrict deformation of the outer peripheral side ring portion, and an inner peripheral side deformation restricting part is structured for supporting an inner peripheral side ring portion that is located between the inner peripheral side held part and the deformable part of the diaphragm to restrict deformation of the inner peripheral side ring portion. Therefore, even when the piston is displaced, the outer peripheral side ring portion and the inner peripheral side ring portion of the diaphragm do not deform unnecessarily. Especially, in a case that the diaphragm cylinder device to which the present invention is applied is structured as a diaphragm pump device in which fluid is flown in and flown out in the chamber on basis of displacement of the piston in the axial direction, even when the piston is displaced toward the bottom dead point side and the chamber becomes in a negative pressure state, deformation of the outer peripheral side ring portion and the inner peripheral side ring portion due to the negative pressure in the chamber can be restrained.

In accordance with an embodiment of the present invention, the turning-back portion of the deformable part is located on a bottom dead point side with respect to the outer peripheral side held part and the inner peripheral side held part. According to this structure, even when pressure of the fluid is increased by decreasing the internal volume in the chamber, unnecessary deformation of the turning-back portion is prevented. In this case, it is preferable that the outer peripheral side deformation restricting part is formed so as to extend from the top dead point side to the bottom dead point side in the chamber so that the outer peripheral side ring portion of the diaphragm is guided to extend from the top dead point side toward the bottom dead point side and an inner peripheral side of the outer peripheral side ring portion of the diaphragm is supported by the outer peripheral side deformation restricting part, and the inner peripheral side deformation restricting part is formed so as to extend from the top dead point side to the bottom dead point side in the chamber so that the inner peripheral side ring portion of the diaphragm is guided to extend from the top dead point side toward the bottom dead point side and an outer peripheral side of the inner peripheral side ring portion of the diaphragm is supported by the inner peripheral side deformation restricting part.

In accordance with an embodiment of the present invention, a bottom dead point side end part of the outer peripheral side deformation restricting part is located in a vicinity of a position where the turning-back portion is located when the piston has reached to the top dead point, and a bottom dead point side end part of the inner peripheral side deformation restricting part is located in a vicinity of a position where the turning-back portion is located when the piston has reached to the bottom dead point. According to this structure, unnecessary deformation of the diaphragm can be prevented over the entire range of a stroke of the piston.

In accordance with an embodiment of the present invention, a gap space is formed between the bottom dead point side end part of the outer peripheral side deformation restricting part and the outer peripheral side ring portion so that a width dimension of the gap space is continuously increased toward a tip end side of the bottom dead point side end part, and a gap space is formed between the bottom dead point side end part of the inner peripheral side deformation restricting part and the inner peripheral side ring portion so that a width dimension of the gap space is continuously increased toward a tip end side of the bottom dead point side end part. According to this structure, even when the diaphragm is deformed toward the end part of the outer peripheral side deformation restricting part or toward the end part of the inner peripheral side deformation restricting part, the diaphragm does not abut with the end part of the outer peripheral side deformation restricting part or toward the end part of the inner peripheral side deformation restricting part. Alternatively, even when the diaphragm is abutted with the end part of the outer peripheral side deformation restricting part or with the end part of the inner peripheral side deformation restricting part, a coercive deformation is not occurred in the diaphragm. Therefore, deterioration and damage of the diaphragm is prevented and thus reliability of the diaphragm cylinder device can be enhanced.

In accordance with an embodiment of the present invention, the fixed body includes a first fixing member, which is located on a bottom dead point side with respect to the outer peripheral side held part, and a second fixing member which is located on a top dead point side with respect to the outer peripheral side held part for holding the outer peripheral side held part between the first fixing member and the second fixing member, and the first fixing member includes a cylinder peripheral wall, which is extended in an axial direction, on an inner peripheral side of a holding portion for the outer peripheral side held part, and the outer peripheral side deformation restricting part is provided in the second fixing member on the inner peripheral side with respect to the cylinder peripheral wall so as to extend in the axial direction and to hold the outer peripheral side ring portion between the cylinder peripheral wall and the outer peripheral side deformation restricting part. Further, the piston includes a first piston member, which is located on the bottom dead point side with respect to the inner peripheral side held part, and a second piston member which is located on the top dead point side with respect to the inner peripheral side held part for holding the inner peripheral side held part between the first piston member and the second piston member, and the first piston member includes a piston peripheral wall, which is extended in the axial direction, on an outer peripheral side of a holding portion for the inner peripheral side held part, and the inner peripheral side deformation restricting part is provided in the second piston member on the outer peripheral side with respect to the piston peripheral wall so as to extend in the axial direction and to hold the inner peripheral side ring portion between the piston peripheral wall and the inner peripheral side deformation restricting part. According to this structure, in the fixed body, the outer peripheral side deformation restricting part may be structured by using a part of the second fixing member which is used for fixing the outer peripheral side held part of the diaphragm. Further, in the piston, the inner peripheral side deformation restricting part may be structured by using a part of the second piston member which is used for fixing the inner peripheral side held part of the diaphragm. Therefore, an additional component is not required to prevent unnecessary deformation of the diaphragm and thus increase of cost can be prevented. Further, since the structure of the fixed body and the piston can be simplified, increase of dead volume in the chamber can be prevented.

In accordance with an embodiment of the present invention, the holding portion of the first fixing member for the outer peripheral side held part is formed in a direction perpendicular to the axial direction, and the holding portion and the cylinder peripheral wall are connected with each other through a curved face, and the holding portion of the second fixing member for the outer peripheral side held part is formed in a direction perpendicular to the axial direction, and the holding portion and the outer peripheral side deformation restricting part are connected with each other through a curved face. Further, the holding portion of the first piston member for the inner peripheral side held part is formed in a direction perpendicular to the axial direction, and the holding portion and the piston peripheral wall are connected with each other through a curved face, and the holding portion of the second piston member for the inner peripheral side held part is formed in a direction perpendicular to the axial direction, and the holding portion and the inner peripheral side deformation restricting part are connected with each other through a curved face. According to this structure, a large stress is not applied to the portion of the diaphragm which is held by the first fixing member and the second fixing member and to the portion of the diaphragm which is held by the first piston member and the second piston member in a concentrated manner at a part of the diaphragm. Therefore, deterioration and damage of the diaphragm is prevented and thus reliability of the diaphragm cylinder device can be enhanced.

In accordance with an embodiment of the present invention, an edge portion on an outer peripheral side of the bottom dead point side end part of the outer peripheral side deformation restricting part is formed in an “R” shape having no edge, and an edge portion on an inner peripheral side of the bottom dead point side end part of the inner peripheral side deformation restricting part is formed in an “R” shape having no edge. According to this structure, even when the diaphragm is abutted with the end part of the outer peripheral side deformation restricting part and the end part of the inner peripheral side deformation restricting part, coercive deformation is not occurred in the diaphragm. Therefore, deterioration and damage of the diaphragm is prevented and thus reliability of the diaphragm cylinder device can be enhanced.

At least an embodiment of the present invention is effective in a case that the diaphragm cylinder device is structured as a pump device in which fluid is flown in and flown out in the chamber on the basis of displacement of the piston in the axial direction.

The present invention may be applied to a case that the diaphragm cylinder device is structured as an actuator in which displacement of the piston in the axial direction is outputted to the outside on the basis of flowing-in and flowing-out of fluid in the chamber.

In accordance with an embodiment of the present invention, an outer peripheral side deformation restricting part is structured for supporting the outer peripheral side ring portion that is located between the outer peripheral side held part and the deformable part of the diaphragm to restrict deformation of the outer peripheral side ring portion, and an inner peripheral side deformation restricting part is structured for supporting the inner peripheral side ring portion that is located between the inner peripheral side held part and the deformable part of the diaphragm to restrict deformation of the inner peripheral side ring portion. Therefore, even when the piston is displaced, the outer peripheral side ring portion and the inner peripheral side ring portion of the diaphragm do not deform unnecessarily. Accordingly, since linearity is secured between the internal volume of the chamber and the position of the piston, operating characteristics as an actuator and a pump device can be improved. Especially, in a case that the diaphragm cylinder device to which at least an embodiment of the present invention may be applied is structured as a diaphragm pump device in which fluid is flown in and flown out in the chamber on the basis of displacement of the piston in the axial direction, even when the piston is displaced toward the bottom dead point side and the chamber becomes in a negative pressure state, deformation of the outer peripheral side ring portion and the inner peripheral side ring portion due to the negative pressure in the chamber is prevented and thus linearity is secured between the internal volume of the chamber and the position of the piston. Therefore, in the diaphragm pump device to which the present invention may be applied, a high degree of discharging accuracy can be obtained. Further, when the diaphragm cylinder device to which the present invention may be applied is used as a diaphragm pump device for mixing, mixing can be performed with a high degree of accuracy. Further, since unnatural deformation of the diaphragm is not occurred, deterioration of the diaphragm can be restrained.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1(a) and 1(b) are longitudinal sectional views showing a diaphragm pump device (diaphragm cylinder device) in accordance with an embodiment of the present invention.

FIG. 2(a) is an enlarged cross-sectional view showing an outer peripheral side deformation restricting part and FIG. 2(b) is an enlarged cross-sectional view showing an inner peripheral side deformation restricting part, which are provided in a diaphragm pump device in accordance with an embodiment of the present invention.

FIGS. 3(a) and 3(b) are longitudinal sectional views showing an actuator (diaphragm cylinder device) in accordance with an embodiment of the present invention.

FIGS. 4(a1), 4(a2) and 4(b) are explanatory views schematically showing operations of the actuator shown in FIGS. 3(a) and 3(b).

FIGS. 5(a) and 5(b) are longitudinal sectional views showing a conventional diaphragm cylinder device.

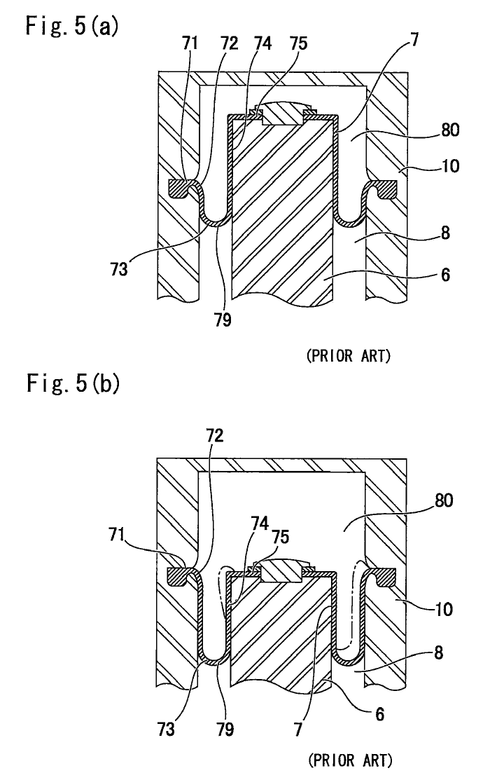

### DETAILED DESCRIPTION OF THE PREFERRED EMBODIMENTS

Embodiments of the present invention will be described with reference to the accompanying drawings. An example in which a diaphragm cylinder device is structured as a diaphragm pump device will be described as a first embodiment and a diaphragm cylinder device is structured as an actuator will be described as a second embodiment.

### First Embodiment

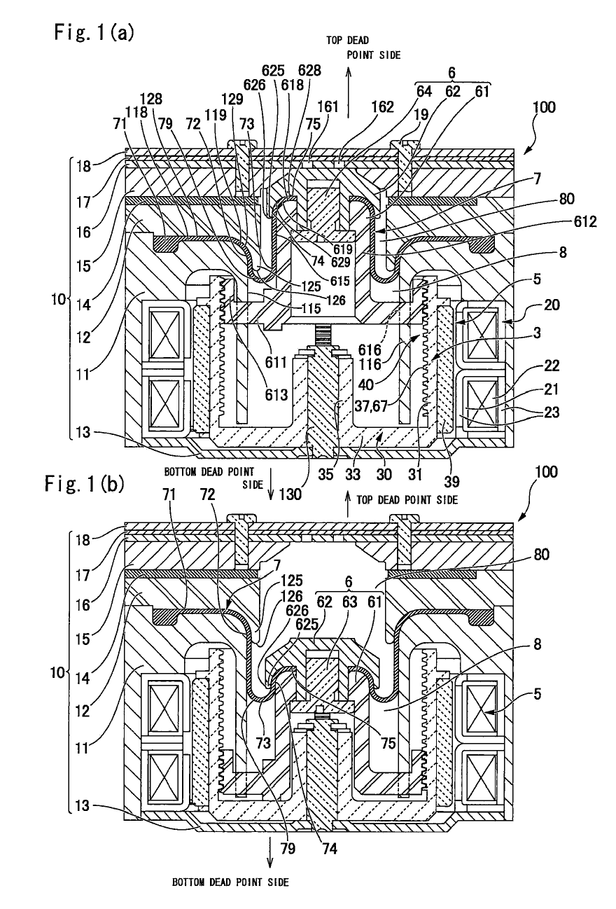

FIGS. 1(a) and 1(b) are longitudinal sectional views showing a diaphragm pump device in accordance with an embodiment of the present invention. FIG. 1(a) shows a state where a piston is located at the top dead point and FIG. 1(b) shows a state where the piston is located at the bottom dead point.

In FIG. 1(a), a diaphragm pump device 100 (diaphragm cylinder device) in the first embodiment is a pump device in which liquid is sucked and discharged. The diaphragm pump device 100 includes a cylinder chamber 8 extending in an axial direction in an inside of a fixed body 10, a piston 6 disposed in an inside of the cylinder chamber 8, and a diaphragm 7 whose outer peripheral side and inner peripheral side are respectively fixed to the fixed body 10 and the piston 6. The diaphragm 7 partitions and forms a chamber 80 in the cylinder chamber 8 where fluid is flown in and flown out. A drive device 5 for driving the piston 6 in the axial direction of the cylinder chamber 8 is structured in the diaphragm pump device 100. The drive device 5 reciprocatedly moves the piston 6 between the top dead point where the internal volume of the chamber 80 has been reduced as shown in FIG. 1(a) and the bottom dead point where its internal volume has been expanded as shown in FIG. 1(b).

In the fixed body 10 in this embodiment, a base 13, a first fixing member 11, a second fixing member 12, a packing 14 for seal, an intermediate plate 15, a flow passage structuring plate 16, a sheet 17 for seal, and a cover 18 are disposed so as to superpose on each other in this order from the bottom dead point side to the top dead point side and these members are fixed to each other by screws 19 and the like.

The first fixing member 11, the second fixing member 12, the packing 14 for seal and the intermediate plate 15 are respectively formed with a circular hole at mutually overlapped positions with each other and the cylinder chamber 8 having a cylindrical space is structured by using these holes. In the cylinder chamber 8, a space of two spaces partitioned by the diaphragm 7 which is located on the top dead point side is the chamber 80. In this embodiment, the chamber 80 is formed, for example, in a diameter of about 7.6 mm and, in this case, an outer diameter dimension of the piston 6 is set to be about 7.0 mm.

Opening parts structuring flow paths are formed in a predetermined pattern in the flow passage structuring plate 16 and an inflow port 161 and an outflow port 162 for fluid among the opening parts are opened in the chamber 80. Further, the drive device 5 is structured between the base 13 and the first fixing member 11.

The drive device 5 includes a ring shaped stator 20, a rotatable body 3 which is coaxially disposed on an inner side of the stator 20, the piston 6 which is coaxially disposed on an inner side of the rotatable body 3, and a conversion mechanism 40 for converting rotation of the rotatable body 3 into a force for moving the piston 6 in the axial direction to be transmitted to the piston 6. In the drive device 5, the stator 20 is structured so that two units comprising a coil 22 wound around a bobbin 21 and two yokes 23 disposed to cover the coil 22 are superposed on each other in the axial direction. In this state, each of the two units is structured so that pole teeth which are protruded from inner circumferential edges of the two yokes in the axial direction are alternately juxtaposed in a circumferential direction.

The rotatable body 3 includes a cup-shaped member 30 which is opened upward and a ring shaped rotor magnet 39 which is fixed to an outer peripheral face of a cylindrical drum part 31 of the cup-shaped member 30. A cylindrical bearing part 35 into which a support shaft 130 standing from the base 13 is fitted is formed at a center of a bottom wall 33 of the cup-shaped member 30 and the cup-shaped member 30 is rotatably supported around the support shaft 130 by the fixed body 10. An upper end part of the support shaft 130 is fixed with a retaining ring, a thrust plate or the like for preventing coming out of the cup-shaped member 30. An outer peripheral face of the rotor magnet 39 of the rotatable body 3 is faced to the pole teeth which are juxtaposed in the circumferential direction along an inner peripheral face of the stator 20. An “S”-pole and an “N”-pole are alternately formed in the circumferential direction on the outer peripheral face of the rotor magnet 39. The stator 20 and the cup-shaped member 30 structure a stepping motor.

In this embodiment, the piston 6 includes a first piston member 61 which is formed in a hat shape and located at the bottom dead point side and a second piston member 62 which is located at the top dead point side with respect to the first piston member 61. The first piston member 61 and the second piston member 62 are connected with each other by a screw 64 disposed in the inside of the first piston member 61 and an inner peripheral side held part 75 of the diaphragm 7 is pinched between the first piston member 61 and the second piston member 62. The first piston member 61 includes a ring-shaped bottom wall portion 611, an inner peripheral side cylindrical part 612 protruding toward the top dead point side in the axial direction from the center portion of the bottom wall portion 611, and an outer peripheral side cylindrical part 613 which protrudes toward the top dead point side in the axial direction from an outer peripheral portion of the bottom wall portion 611.

In this embodiment, the conversion mechanism 40 for reciprocatedly moving the piston 6 in the axial direction through rotation of the rotatable body 3 is structured as follows. In other words, an inner peripheral face of the drum part 31 of the cup-shaped member 30 is formed with female screws 37 at plural separated portions in the circumferential direction, and an outer peripheral face of the outer peripheral side cylindrical part 613 of the first piston member 61 is formed with a male screw 67 which engages with the female screw 37 of the cup-shaped member 30 to structure a transmission mechanism. Therefore, when the first piston member 61 is disposed on the inner side of the cup-shaped member 30 so that the male screw 67 and the female screw 37 are engaged with each other, the piston 6 is supported in the inside of the cup-shaped member 30. Further, the bottom wall portion 611 of the piston 6 is formed with a plurality of through holes 616 in the circumferential direction and projections 116 which are fitted to the through holes 616 are formed in the first fixing member 11 as the fixed body 10 and, in this manner, a co-rotation preventing mechanism is structured. In other words, when the cup-shaped member 30 is rotated, rotation of the piston 6 is prevent by the co-rotation preventing mechanism comprised of the projections 116 and the through holes 616 and thus rotation of the cup-shaped member 30 is transmitted to the piston 6 through the transmission mechanism comprised of its female screw 37 and the male screw 67 of the piston 6. As a result, the piston 6 is linearly moved to one side and the other side in the axial direction depending on a rotating direction of the rotatable body 3.

The diaphragm 7 is made of a circular thin rubber sheet and is provided with the outer peripheral side held part 71, which is formed in a ring shape and pinched between the first fixing member 11 and the second fixing member 12 of the fixed body 10, the inner peripheral side held part 75 which is held on the piston 6 side, and a deformable part 73 which is formed in a ring shape for varying the internal volume of the chamber 80 by means of that a turning-back portion 79 formed in a “U”-shape in cross section is moved between the outer peripheral side held part 71 and the inner peripheral side held part 75 by displacement of the piston 6. A thickness of roughly entire diaphragm 7 except the thick portion which is the outer peripheral side held part 71 is set to be about 0.25 mm. In this embodiment, the turning-back portion 79 is always located lower on the bottom dead point side than the outer peripheral side held part 71 and the inner peripheral side held part 75.

In the fixed body 10, the first fixing member 11 and the second fixing member 12 are formed with holding faces 118 and 128 which are formed to be perpendicular to the axial direction of the piston 6 for holding the outer peripheral side held part 71 of the diaphragm 7. The holding face 118 is formed with a peripheral groove to which the ring-shaped thicker portion of the outer peripheral side held part 71 of the diaphragm 7 is fitted. In this manner, the outer peripheral side held part 71 of the diaphragm 7 is fixed to the fixed body 10 in a tight contacted state.

The first fixing member 11 is provided with a cylinder peripheral wall 115 extending toward the bottom dead point side in the axial direction on an inner peripheral side of the holding face 118 for the outer peripheral side held part 71. The cylinder peripheral wall 115 and the holding face 118 are connected to each other through a curved face 119 having a large radius of curvature. In this embodiment, the radius of curvature of the curved face 119 is about 1.5 mm.

The second fixing member 12 is provided with an outer peripheral side deformation restricting part 125, which is extended toward the bottom dead point side in the axial direction for guiding the outer peripheral side ring portion 72 so as to extend toward the bottom dead point side, on the inner peripheral side of the holding face 128 with respect to the outer peripheral side held part 71. The outer peripheral side deformation restricting part 125 and the holding face 128 are connected to each other through a curved face 129 having a large radius of curvature. The radius of curvature of the curved face 129 is equivalent to the radius of curvature of the curved face 119 to be set about 1.5 mm. Function and the like of the outer peripheral side deformation restricting part 125 will be described below.

In the piston 6, the first piston member 61 and the second piston member 62 are provided with holding faces 618 and 628 which are formed to be perpendicular to the axial direction of the piston 6 in order to hold the inner peripheral side held part 75 of the diaphragm 7 and thus the inner peripheral side held part 75 of the diaphragm 7 is fixed to the piston 6 in a tight contacted state.

The first piston member 61 is provided with a piston peripheral wall 615 extending toward the bottom dead point side in the axial direction on an outer peripheral side with respect to the holding face 618 for the inner peripheral side held part 75. The piston peripheral wall 615 and the holding face 618 are connected to each other through a curved face 619 having a large radius of curvature. In this embodiment, the radius of curvature of the curved face 619 is about 0.8 mm.

Further, the second piston member 62 is provided with an inner peripheral side deformation restricting part 625 which is extended toward the bottom dead point side in the axial direction for guiding the inner peripheral side ring portion 74 so as to extend toward the bottom dead point side, on an outer peripheral side with respect to the holding face 628 for the inner peripheral side held part 75. The inner peripheral side deformation restricting part 625 and the holding face 628 are connected to each other through a curved face 629 having a large radius of curvature. The radius of curvature of the curved face 629 is equivalent to the radius of curvature of the curved face 619 and sets in about 1.5 mm. Function and the like of the inner peripheral side deformation restricting part 625 will be described below.

In the diaphragm pump device 100 structured as described above, the deformable part 73 of the diaphragm 7 is disposed so that the turning-back portion 79 having a “U”-shape in cross section is formed within a narrow space whose width is about 1.5 mm. When the piston 6 is moved from the top dead point shown in FIG. 1(a) to the bottom dead point shown in FIG. 1(b) by the drive device 5, the turning-back portion 79 of the diaphragm 7 deforms to move and an internal volume of the chamber 80 is expanded and thus the inside of the chamber 80 becomes in a negative pressure state. As a result, fluid flows into the chamber 80 from the inflow port 161. On the other hand, the piston 6 is moved from the bottom dead point shown in FIG. 1(b) to the top dead point shown in FIG. 1(a) by the drive device 5, the internal volume of the chamber 80 is reduced and thus the inside of the chamber 80 becomes in a positive pressure state. As a result, the fluid in the chamber 80 is discharged from the outflow port 162. Also in this case, the turning-back portion 79 of the diaphragm 7 is moved.

When the diaphragm 7 is deformed so as to follow movement of the piston 6 as described above, in a case that the outer peripheral side ring portion 72 of the diaphragm 7 which is located between the outer peripheral side held part 71 and the deformable part 73 is not deformed and the inner peripheral side ring portion 74 located between the inner peripheral side held part 75 and the deformable part 73 is not deformed, in other words, when non-deformable parts are provided, linearity is secured between the internal volume of the chamber 80 and the position of the piston 6. On the contrary, when the piston 6 is moved, if the outer peripheral side ring portion 72 and/or the inner peripheral side ring portion 74 are deformed, linearity between the internal volume of the chamber 80 and the position of the piston 6 is deteriorated. Especially, in a case of the diaphragm pump device 100, when the piston 6 is displaced toward the bottom dead point side to cause the chamber 80 to be in a negative pressure state, the outer peripheral side ring portion 72 and the inner peripheral side ring portion 74 may be sucked to deform on the chamber 80 side due to the negative pressure in the chamber 80.

According to this embodiment, the second fixing member 12 is formed with the outer peripheral side deformation restricting part 125 extending toward the bottom dead point side in the axial direction on the inner peripheral side with respect to the holding face 128 for the outer peripheral side held part 71. The outer peripheral side deformation restricting part 125 supports the outer peripheral side ring portion 72 of the diaphragm 7 so as not to deform in the chamber 80 when the deformable part 73 of the diaphragm 7 is deformed according to movement of the piston 6. Therefore, even when the piston 6 is displaced toward the bottom dead point side and the inside of the chamber 80 becomes in a negative pressure state, the outer peripheral side ring portion 72 does not deform.

Further, in this embodiment, the second piston member 62 is formed with the inner peripheral side deformation restricting part 625 extending toward the bottom dead point side in the axial direction on the outer peripheral side with respect to the holding face 628 for the inner peripheral side held part 75. The inner peripheral side deformation restricting part 625 supports the inner peripheral side ring portion 74 of the diaphragm 7 so as not to deform in the chamber 80 when the deformable part 73 of the diaphragm 7 is deformed according to movement of the piston 6. Therefore, even when the piston 6 is displaced toward the bottom dead point side and the inside of the chamber 80 becomes in a negative pressure state, the inner peripheral side ring portion 74 does not deform.

In this embodiment, the outer peripheral side deformation restricting part 125 is extended from the top dead point side toward the bottom dead point side in the chamber 80 and, as shown in FIG. 1(a), when the piston 6 has reached to the top dead point, a bottom dead point side end part 126 of the outer peripheral side deformation restricting part 125 is located in the vicinity at a position where the turning-back portion 79 is located. Further, the inner peripheral side deformation restricting part 625 is extended toward the bottom dead point side from the top dead point side in the chamber 80 and, as shown in FIG. 1(b), when the piston 6 has reached to the bottom dead point, a bottom dead point side end part 626 of the inner peripheral side deformation restricting part 625 is located in the vicinity at a position where the turning-back portion 79 is located. Therefore, unnecessary deformation of the diaphragm is prevented over the entire range of a stroke of the piston 6.

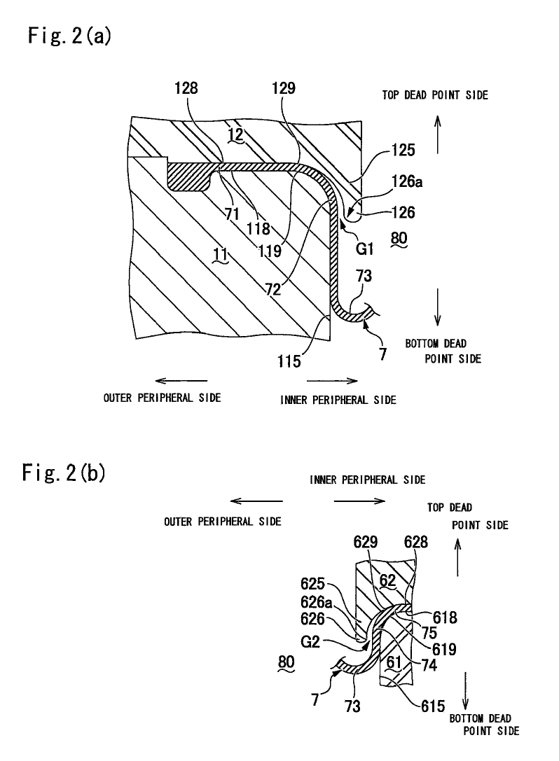

Further, as shown by an enlarged view in FIG. 2(a), a gap space “G1” whose width dimension is continuously increased toward the tip end side of the bottom dead point side end part 126 is provided between the bottom dead point side end part 126 of the outer peripheral side deformation restricting part 125 and the outer peripheral side ring portion 72 of the diaphragm 7. Further, an edge portion 126a on an outer peripheral side of the bottom dead point side end part 126 of the outer peripheral side deformation restricting part 125 is formed in an “R”-shape having no edge and its radius of curvature is about 0.3 mm. Therefore, even when the diaphragm 7 is deformed toward the bottom dead point side end part 126 of the outer peripheral side deformation restricting part 125, the diaphragm 7 does not abut with the bottom dead point side end part 126 of the outer peripheral side deformation restricting part 125. Alternatively, even when the diaphragm 7 is abutted with the bottom dead point side end part 126 of the outer peripheral side deformation restricting part 125, a coercive deformation is not occurred in the diaphragm 7. Therefore, deterioration and damage of the diaphragm 7 is prevented and thus reliability of the diaphragm cylinder device 100 can be enhanced.

Further, as shown by an enlarged view in FIG. 2(b), a gap space “G2” whose width dimension is continuously increased toward the tip end side of the bottom dead point side end part 626 is provided between the bottom dead point side end part 626 of the inner peripheral side deformation restricting part 625 and the inner peripheral side ring portion 74 of the diaphragm 7. Further, an edge portion 626a on an inner peripheral side of the bottom dead point side end part 626 of the inner peripheral side deformation restricting part 625 is formed in an “R”-shape having no edge and its radius of curvature is about 0.2 mm. Therefore, even when the diaphragm 7 is deformed toward the bottom dead point side end part 626 of the inner peripheral side deformation restricting part 625, the diaphragm 7 does not abut with the bottom dead point side end part 626 of the inner peripheral side deformation restricting part 625. Alternatively, even when the diaphragm 7 is abutted with the bottom dead point side end part 626 of the inner peripheral side deformation restricting part 125, a coercive deformation is not occurred in the diaphragm 7. Therefore, deterioration and damage of the diaphragm 7 is prevented and thus reliability of the diaphragm cylinder device 100 can be enhanced.

As described above, in the diaphragm pump device 100 in this embodiment, the outer peripheral side deformation restricting part 125 for restricting deformation of the outer peripheral side ring portion 72 is structured between the outer peripheral side held part 71 and the deformable part 73 of the diaphragm 7, and the inner peripheral side deformation restricting part 625 for restricting deformation of the inner peripheral side ring portion 74 is structured between the inner peripheral side held part 75 and the deformable part 73 of the diaphragm 7. Therefore, when the piston 6 is displaced, the outer peripheral side ring portion 72 and the inner peripheral side ring portion 74 of the diaphragm 7 do not deform unnecessarily. Accordingly, linearity is secured between the internal volume of the chamber 80 and the position of the piston 6. Especially, in the diaphragm pump device 100, even when the piston 6 is displaced toward the bottom dead point side to cause the chamber 80 to be in a negative pressure state, the outer peripheral side ring portion 72 and the inner peripheral side ring portion 74 are not deformed by the negative pressure in the chamber 80. Therefore, linearity between the internal volume of the chamber 80 and the position of the piston 6 is surely secured. Accordingly, the diaphragm pump device 100 in this embodiment is provided with a high degree of discharging accuracy. Further, when the diaphragm pump device 100 in this embodiment is used as a mixing pump device in which a plurality of fluids has been sucked into the chamber 80 corresponding to displacement of the piston 6 to be mixed in the chamber 80 for being discharged, the mixing is performed with a high degree of accuracy. Further, since unnatural deformation of the diaphragm 7 is not occurred, deterioration of the diaphragm 7 is restrained.

Further, in this embodiment, the outer peripheral side deformation restricting part 125 is structured by using a part of the second fixing member 12 which is used to fix the outer peripheral side held part 71 of the diaphragm 7 and the inner peripheral side deformation restricting part 625 is structured by using a part of the second piston member 62 which is used to fix the inner peripheral side held part 75 of the diaphragm 7. Therefore, an additional component is not required to prevent unnecessary deformation of the diaphragm 7 and thus increase of cost can be prevented. Further, since the structure of the fixed body 10 and the piston 6 can be simplified, increase of dead volume in the chamber 80 can be prevented.

In addition, the diaphragm 7 on the fixed body 10 side is sandwiched between the curved faces 119 and 129 of the first fixing member 11 and the second fixing member 12, and the diaphragm 7 on the piston 6 side is sandwiched between the curved faces 619 and 629 of the first piston member 61 and the second piston member 62. Therefore, a large stress is not applied to a part of the diaphragm 7 in a concentrated manner. As a result, even when the size of the diaphragm pump device 100 is reduced, there is no portion of the diaphragm 7 which is steeply bent and thus deterioration and damage of the diaphragm 7 is prevented. Accordingly, reliability of the diaphragm pump device 100 can be enhanced.

In the first embodiment described above, liquid is sucked and discharged in diaphragm pump device 100. However, in other embodiments of a diaphragm pump device 100, gas can be inhaled or sucked and discharged. Further, in the first embodiment described above, the drive device 5 in a stepping motor structure is incorporated into the inside of the diaphragm pump device 100. However, in alternative embodiments, a driving force may be transmitted to a piston through a gear mechanism from an external stepping motor which is provided outside of the diaphragm pump device. Further, in at least some embodiments a piston is driven by using other types of an actuator.

### Second Embodiment

In the first embodiment, the diaphragm cylinder device is applied to a diaphragm pump device. However, in the second embodiment, a piston is displaced in an axial direction in an actuator on the basis of flowing-in and flowing-out of fluid in a chamber and its displacement is outputted to the outside.

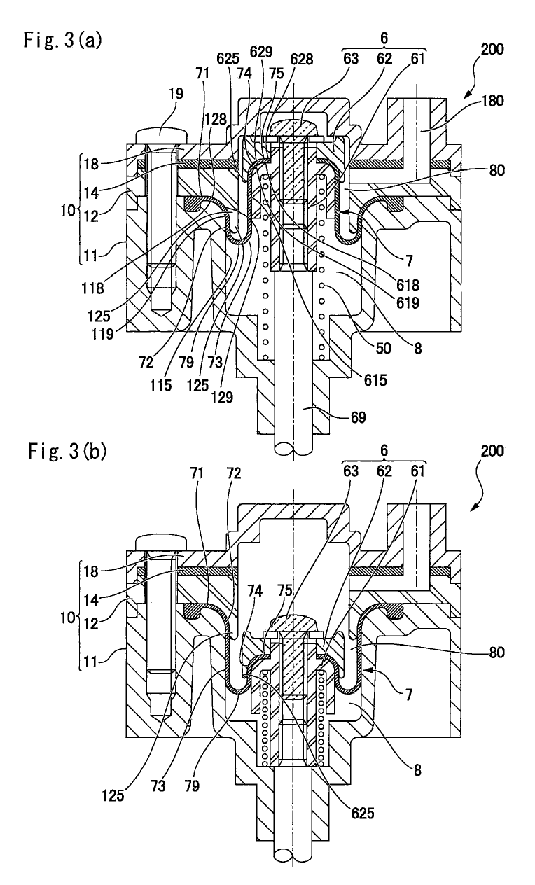

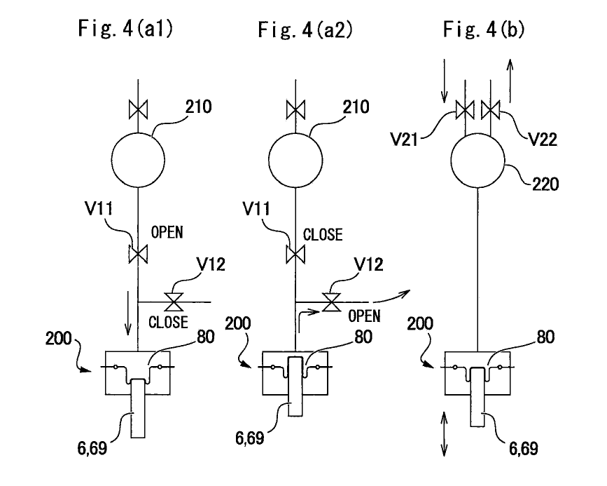

FIGS. 3(a) and 3(b) are longitudinal sectional views showing an actuator. FIG. 3(a) shows a state where a piston is located at the top dead point and FIG. 3(b) shows a state where the piston is located at the bottom dead point. FIGS. 4(a1), 4(a2) and 4(b) are explanatory views schematically showing operations of the actuator. In this actuator in the second embodiment, a structure as a diaphragm cylinder device is similar to the first embodiment. Therefore, in order to be easily understood, the same notational symbol is used in a portion having the same function.

In FIGS. 3(a) and 3(b), an actuator 200 (diaphragm cylinder device) in the second embodiment includes a cylinder chamber 8 extending in an axial direction in a fixed body 10, a piston 6 disposed in an inside of the cylinder chamber 8, and a diaphragm 7 whose outer peripheral side and inner peripheral side are respectively fixed to the fixed body 10 and the piston 6. The diaphragm 7 partitions and forms a chamber 80 in the cylinder chamber 8 where fluid is flown in and flown out. A coil spring 50 is disposed between the piston 6 and a bottom part of the fixed body 10 and the piston 6 is urged toward the top dead point side by the coil spring 50. Further, the actuator 200 is connected with an output shaft 69 which is connected with the piston 6 and displacement of the piston 6 is transmitted to the outside through the output shaft 69.

In the actuator 200 structured as described above, for example, as shown in FIG. 4(a1), an operation where a valve “V11” is opened, a valve “V12” is closed and fluid is flown into the chamber 80 by a pump 210 and, as shown in FIG. 4(a2), an operation where the valve “V11” is closed, the valve “V12” is opened and the fluid is flown out from the chamber 80, may be repeated. When the two operations are repeated, the piston 6 is reciprocated in the axial direction and thus these operations are outputted as a reciprocating linear-motion through the output shaft 69.

Further, as shown in FIG. 4(b), an operation where a valve “V21” is opened, a valve “V22” is closed and fluid is flown into the chamber 80 by a pump 220 and, an operation where the valve “V21” is closed, the valve “V22” is opened and the fluid is flown out from the chamber 80, may be repeated. When the two operations are repeated, the piston 6 is reciprocated in the axial direction and thus these operations are outputted as a reciprocating linear-motion through the output shaft 69.

In the actuator 200 shown in FIG. 3(a) in this embodiment, the fixed body 10 is disposed so that the first fixed side member 11, the second fixed side member 12, the packing 14 for seal and the cover 18 are superposed on each other in this order from the bottom dead point side toward the top dead point side and these members are fixed to each other by the screw 19 and the like. Further, a flowing-in-and-out port 180 communicating with the chamber 80 is formed in the second fixed side member 12, the packing 14 and the cover 18.

Also in the actuator 200 structured as described above, similar to the first embodiment, the diaphragm 7 includes a ring-shaped outer peripheral side held part 71 which is held between the first fixed side member 11 and the second fixed side member 12 of the fixed body 10, an inner peripheral side held part 75 which is held on the piston 6 side, and a deformable part 73 which is formed in a ring shape for varying the internal volume of the chamber 80 by means of that a turning-back portion 79 formed in a “U”-shape in cross section is moved between the outer peripheral side held part 71 and the inner peripheral side held part 75 by displacement of the piston 6.

The first fixing member 11 is provided with a cylinder peripheral wall 115 extending toward the bottom dead point side in the axial direction on an inner peripheral side of the holding face 118 for the outer peripheral side held part 71. The cylinder peripheral wall 115 and the holding face 118 are connected to each other through a curved face 119 having a large radius of curvature. The second fixing member 12 is provided with an outer peripheral side deformation restricting part 125, which is extended toward the bottom dead point side in the axial direction for guiding the outer peripheral side ring portion 72 so as to extend toward the bottom dead point side, on the inner peripheral side of the holding face 128 with respect to the outer peripheral side held part 71. The outer peripheral side deformation restricting part 125 and the holding face 128 are connected to each other through a curved face 129 having a large radius of curvature.

The piston 6 includes a first piston member 61 and a second piston member 62 which are connected with each other by a screw member 63. The first piston member 61 is provided with a piston peripheral wall 615 extending toward the bottom dead point side in the axial direction on an outer peripheral side with respect to the holding face 618 for the inner peripheral side held part 75. The piston peripheral wall 615 and the holding face 618 are connected to each other through a curved face 619 having a large radius of curvature. Further, the second piston member 62 is provided with an inner peripheral side deformation restricting part 625 which is extended toward the bottom dead point side in the axial direction for guiding the inner peripheral side ring portion 74 so as to extend toward the bottom dead point side, on an outer peripheral side with respect to the holding face 628 for the inner peripheral side held part 75. The inner peripheral side deformation restricting part 625 and the holding face 628 are connected to each other through a curved face 629 having a large radius of curvature.

Other structures are similar to the first embodiment and thus their descriptions are omitted. In the actuator 200 structured as described above, when fluid is flown into the chamber 80, the piston 6 is moved from the top dead point shown in FIG. 3(a) to the bottom dead point shown in FIG. 3(b). On the other hand, when the fluid is to be flown out from the chamber 80, the piston 6 is pressed by the coil spring 50 to be moved from the bottom dead point shown in FIG. 3(b) to the top dead point shown in FIG. 3(a). During these operations, the turning-back portion 79 of the deformable part 73 of the diaphragm 7 is moved and thus movement of the piston 6 is permitted to vary the internal volume of the chamber 80.

In this case, the outer peripheral side deformation restricting part 125 for restricting deformation of the outer peripheral side ring portion 72 is structured between the outer peripheral side held part 71 and the deformable part 73 of the diaphragm 7, and the inner peripheral side deformation restricting part 625 for restricting deformation of the inner peripheral side ring portion 74 is structured between the inner peripheral side held part 75 and the deformable part 73 of the diaphragm 7. Therefore, when the piston 6 is displaced, the outer peripheral side ring portion 72 and the inner peripheral side ring portion 74 of the diaphragm 7 do not deform unnecessarily. As a result, linearity is secured between the internal volume of the chamber 80 and the position of the piston 6. Accordingly, an operation corresponding to flowing-in and flowing-out of fluid to the chamber 80 is performed by the piston 6.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A diaphragm cylinder device comprising:
a cylinder chamber extended in an axial direction in a fixed body;
a piston disposed in an inside of the cylinder chamber; and
a diaphragm comprising an outer peripheral side and an inner periphery side, wherein the outer peripheral side and the inner peripheral side are respectively fixed to the fixed member and the piston for forming a chamber in the cylinder chamber where fluid is flown into and flown out;
wherein the diaphragm further comprises:
an outer peripheral side held part which is held by the fixed body;
an inner peripheral side held part which is held by the piston; and
a deformable part in which a turning-back portion formed in a “U”-shape in cross section is moved between the outer peripheral side held part and the inner peripheral side held part by displacement of the piston to vary an internal volume of the chamber;
wherein the fixed body includes an outer peripheral side deformation restricting part structured to support an outer peripheral side ring portion of the diaphragm and restrict deformation of the outer peripheral side ring portion when the piston is displaced, wherein the outer peripheral side ring portion is located between the outer peripheral side held part and the deformable part of the diaphragm;
wherein the piston includes an inner peripheral side deformation restricting part structured to support an inner peripheral side ring portion of the diaphragm and restrict deformation of the inner peripheral side ring portion when the piston is displaced, wherein the inner peripheral side ring portion is located between the inner peripheral side held part and the deformable part of the diaphragm on an outer peripheral side with respect to the inner peripheral side ring portion in the chamber for restricting deformation of the inner peripheral side ring portion when the piston is displaced; and
wherein displacement of the piston in a direction toward a top dead point for decreasing an internal volume of the chamber and in a direction toward a bottom dead point for increasing the internal volume of the chamber is interlocked with flowing-out and flowing-in of the fluid in the chamber.

2. The diaphragm cylinder device according to claim 1, wherein the turning-back portion of the deformable part is located on a bottom dead point side with respect to the outer peripheral side held part and the inner peripheral side held part.

3. The diaphragm cylinder device according to claim 2, wherein
the outer peripheral side deformation restricting part extends from a top dead point side to the bottom dead point side in the chamber so that the outer peripheral side ring portion of the diaphragm extends from the top dead point side toward the bottom dead point side and an inner peripheral side of the outer peripheral side ring portion of the diaphragm is supported by the outer peripheral side deformation restricting part, and
the inner peripheral side deformation restricting part extends from the top dead point side to the bottom dead point side in the chamber so that the inner peripheral side ring portion of the diaphragm extends from the top dead point side toward the bottom dead point side and an outer peripheral side of the inner peripheral side ring portion of the diaphragm is supported by the inner peripheral side deformation restricting part.

4. The diaphragm cylinder device according to claim 3, wherein
a bottom dead point side end part of the outer peripheral side deformation restricting part is located in a vicinity of the turning-back portion when the piston has reached to the top dead point, and
a bottom dead point side end part of the inner peripheral side deformation restricting part is located in a vicinity of the turning-back portion when the piston has reached to the bottom dead point.

5. The diaphragm cylinder device according to claim 3, wherein
a gap space is formed between the bottom dead point side end part of the outer peripheral side deformation restricting part and the outer peripheral side ring portion so that a width dimension of the gap space is continuously increased toward a tip end side of the bottom dead point side end part, and
a gap space is formed between the bottom dead point side end part of the inner peripheral side deformation restricting part and the inner peripheral side ring portion so that a width dimension of the gap space is continuously increased toward a tip end side of the bottom dead point side end part.

6. The diaphragm cylinder device according to claim 3, wherein
an edge portion on an outer peripheral side of the bottom dead point side end part of the outer peripheral side deformation restricting part is formed in an “R” shape having no edge, and
an edge portion on an inner peripheral side of the bottom dead point side end part of the inner peripheral side deformation restricting part is formed in an “R” shape having no edge.

7. The diaphragm cylinder device according to claim 1, wherein
the fixed body includes a first fixing member, which is located on a bottom dead point side with respect to the outer peripheral side held part, and a second fixing member which is located on a top dead point side with respect to the outer peripheral side held part for holding the outer peripheral side held part between the first fixing member and the second fixing member,
the first fixing member includes a cylinder peripheral wall, which is extended in an axial direction, on an inner peripheral side of a holding portion for the outer peripheral side held part,
the outer peripheral side deformation restricting part is provided in the second fixing member on the inner peripheral side with respect to the cylinder peripheral wall so as to extend in the axial direction and to hold the outer peripheral side ring portion between the cylinder peripheral wall and the outer peripheral side deformation restricting part,
the piston includes a first piston member, which is located on the bottom dead point side with respect to the inner peripheral side held part, and a second piston member which is located on the top dead point side with respect to the inner peripheral side held part for holding the inner peripheral side held part between the first piston member and the second piston member,
the first piston member includes a piston peripheral wall, which is extended in an axial direction, on an outer peripheral side of a holding portion for the inner peripheral side held part, and
the inner peripheral side deformation restricting part is provided in the second piston member on the outer peripheral side with respect to the piston peripheral wall so as to extend in the axial direction and to hold the inner peripheral side ring portion between the piston peripheral wall and the inner peripheral side deformation restricting part.

8. The diaphragm cylinder device according to claim 7, wherein
a bottom dead point side end part of the outer peripheral side deformation restricting part is located in a vicinity of the turning-back portion when the piston has reached to the top dead point, and
a bottom dead point side end part of the inner peripheral side deformation restricting part is located in a vicinity of the turning-back portion when the piston has reached to the bottom dead point.

9. The diaphragm cylinder device according to claim 7, wherein
the holding portion of the first fixing member for the outer peripheral side held part is formed in a direction perpendicular to the axial direction, and the holding portion and the cylinder peripheral wall are connected with each other through a curved face,
the holding portion of the second fixing member for the outer peripheral side held part is formed in a direction perpendicular to the axial direction, and the holding portion and the outer peripheral side deformation restricting part are connected with each other through a curved face,
the holding portion of the first piston member for the inner peripheral side held part is formed in a direction perpendicular to the axial direction, and the holding portion and the piston peripheral wall are connected with each other through a curved face, and
the holding portion of the second piston member for the inner peripheral side held part is formed in a direction perpendicular to the axial direction, and the holding portion and the inner peripheral side deformation restricting part are connected with each other through a curved face.

10. The diaphragm cylinder device according to claim 7, wherein
an edge portion on an outer peripheral side of a bottom dead point side end part of the outer peripheral side deformation restricting part is formed in an “R” shape having no edge, and
an edge portion on an inner peripheral side of a bottom dead point side end part of the inner peripheral side deformation restricting part is formed in an “R” shape having no edge.

11. The diaphragm cylinder device according to claim 1, further comprising
a drive device for driving the piston in the axial direction of the cylinder chamber,
wherein the drive device includes a stepping motor having a ring-shaped stator and a rotatable body which is coaxially disposed on an inner side of the stator, and the rotatable body includes a cup-shaped member to which a ring-shaped rotor magnet is fixed on an outer peripheral face of a cylindrical drum part of the cup-shaped member, and the piston is disposed on an inner side of the cup-shaped member.

12. The diaphragm cylinder device according to claim 1, wherein the diaphragm cylinder device is structured as a pump device in which fluid is flown in and flown out in the chamber on basis of displacement of the piston in the axial direction.

13. The diaphragm cylinder device according to claim 1, wherein the diaphragm cylinder device is structured as an actuator in which displacement of the piston in the axial direction is outputted to an outside on basis of flowing-in and flowing-out of fluid in the chamber.
